(19) United States
(12) Patent Application Publication
(10) Pub. No.: US 2010/0008728 A1
(43) Pub. Date: Jan. 14, 2010

(54) COMPACTOR AND METHOD OF OPERATION

(76) Inventor: Angus Peter Robson, Matamata (NZ)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(21) Appl. No.: 11/577,978

(22) PCT Filed: Apr. 13, 2007
(86) PCT No.: PCT/NZ07/00081

§ 371 Date: Sep. 29, 2009

(30) Foreign Application Priority Data
Apr. 13, 2006 (NZ) 544578

(51) Int. Cl. B09B 3/00; B02C 1/00

(52) U.S. Cl. 405/129.15; 241/283

(57) ABSTRACT

A compactor (1) including: a transporter (3); an impact tool (10); a lifting mechanism (9) capable of lifting the impact tool (10) to a raised position; a substantially elongate support mast (2) coupled to the lifting mechanism (9) and capable of supporting the raised impact tool (10), and a mast stabilisation system characterised in that the stabilising system is capable of adjusting the orientation of the support mast (2) to allow the impact tool (10) to descend substantially vertically from said raised position without the transmission of any lateral force by the tool (10) to the support mast (9).

### STATEMENT OF CORRESPONDING APPLICATIONS

This application is based on the complete specification filed in relation to New Zealand Patent Application Number NZ544578, the entire contents of which are incorporated herein by reference.

### TECHNICAL FIELD

The invention relates to a compactor and a method for compacting a landfill.

### BACKGROUND ART

Landfills are an increasingly prevalent consequence of human development, urban expansion and the inexorable production of human refuse. Typical landfills are large recesses (either natural land contours or man-made excavations) in a designated site which are successively filled with refuse (predominantly organic or inorganic material), some of which may be subjected to pre-filtering or extraction of recyclable materials. The large land areas required, together with strict operating compliance requirements, mean landfills, and the operation thereof, can be extremely expensive. Furthermore, landfill sites require monitoring for dangerous settlement and any release of dangerous gases or leachate seepage for prolonged periods after the site is filled and sealed. Consequently, there is a strong incentive to maximise the efficiency of a landfill site and reduce the time period before the land may be used for beneficial purposes.

The variable composition of refuse however creates difficulties with the above aims; which are only partially addressed by prior art landfill construction, completion and management techniques.

A typical landfill site may be essentially considered as a fixed usable volume into which refuse may be placed before the site is sealed. Compaction of the refuse thus reduces the percentage of the landfill volume occupied by voids or ‘airspace’ and therefore increases the total amount of refuse that may be disposed of in the landfill. The increase in refuse density produced by mechanical compactors operating over the landfill surface is also complimented by the effect of refuse decomposition. As the organic matter in the waste rots further, voids are created in the landfill. The weight of the waste material itself can also cause a degree of compaction to voids in lower portions. A by-product of the organic matter decomposition is the production of methane gas, which may continue to be produced well after the landfill is full and sealed. Provisions must be made to cater for any methane gas production due to its flammable nature and potent greenhouse gas effect and may, depending on the volumes produced, warrant capturing the gas as stored energy.

Although the volume reduction caused by decomposition of the organic matter is affected by several factors; the predominant effect is moisture content. The type of refuse constituents, the permeability of the landfill (both during filling and after sealing), the rainfall conditions and the design of the landfill all affect the landfill moisture content. It is thus desirable to control the moisture content to facilitate the decomposition process and thereby liberate further volume in the landfill.

Consequently; to optimise the utilisation of limited landfill volumes by maximising the density of the landfill, and minimising air space, several techniques are known in the art.

At virtually all landfill sites, some form of mechanical compactor, bulldozer and roller compactor works the refuse surface, usually applying compacting pressure via rigid spiked wheels. Although typical landfill densities vary widely, they seldom exceed one tonne per cubic metre, even immediately after operation of such mechanical compactors. This is partly due to the constraints of operating a mobile compactor over the surface of variable density and integrity to ensure sufficient ground pressure is applied to achieve compaction; i.e. preventing the compactor from sinking into the surface to such a degree that movement is inhibited without requiring an uneconomically powerful engine.

The risk of a compactor capable of maintaining a good ground pressure becoming stuck may be mitigated by the use of widely separated compactor wheels. However, this has the drawback of creating a thin skin of harder material over the landfill surface and thus reducing the compaction effects on depths greater than about two metres. Considering the configuration of a typical large conventionally wheeled compactor with a wheel footprint of 1.4×0.4 m per wheel and a mass of 50,000 kg generates a resultant static ground pressure of 22,300 kg/m². Even the largest bulldozer or roller compactors only achieve a ground pressure of around 20,000 kilograms per square metre. The ground pressure of a wheeled compactor is however increased by spikes on the wheels and the forward motion of the compactor achieving a ground pressure of approximately 30,000 kg/m².

The degree of compaction possible by such vehicles is thus limited to the surface layer to a depth of approximately two metres.

Prior art compaction devices and techniques for landfill compaction fall into three categories:
vibration methods (often combined with application of a static weight),
high impact compaction, and/or
roller based applications of weight.

U.S. Pat. No. 2,897,734 discloses a method for compacting a landfill which uses a heavy block lowered to the ground via an access aperture in the vehicle chassis. A vibration frequency of several, to several dozen Hertz is applied to the block. The combination of weight and vibration acts to increase density in the soil below the compactor.

However, the effects of this type of compaction are restricted to a shallow surface layer leaving the underlying landfill unaffected.

U.S. Pat. No. 5,244,311 discloses a landfill compaction method using a mass dropped by a crane. Control over the precise impact point is limited however, restricting the ability to compact the surface systematically.

Australian Patent No. 70488 discloses a method of compacting soil through repeated impacts of a dropped weight. The impacts create a momentary state of stress or strain within the soil so that excess pore water pressure in the soil reaches 50 to 80% of the value required to produce liquefaction and is followed by a rest phase during which the interstitial water is allowed to escape. The method therefore relates specifically to soil and its inherent characteristics and is thus not germane to landfill compaction.

Australian Patent Application No. 199715085 is a patent for a tracked vehicle for the compaction of soil. This vehicle utilises weights at both the front and rear of the vehicle which are capable of being raised and dropped repeatedly. However, the maximum height to which the weight may be elevated is restricted, limiting the impact energy attainable by the weights.

U.S. Pat. No. 6,499,542 discloses a device for ground compaction comprising essentially of a mass applied to the ground to achieve compaction through a system of rollers attached to a vehicle. Consequently, the compaction achieved is severely limited and fails to achieve deep soil compaction.

U.S. Pat. No. 6,505,998 discloses a ground treatment device dropped be a crane. The device essentially comprised of some form of pointed nose portion which widens above the tip, (e.g. a conical or frustro-conical section) up to a shoulder portion. The degree of penetration of the device is aided by the pointed nose, while over-penetration is prevented by the shoulder portion. The only means of varying the impact force of the device is to adjust the release height or to change the impact device for a different configuration. These options both provide a means of ensuring the impact forces generated when compacting surfaces of increased toughness (e.g. previously compacted areas) do not exceed any regulatory seismic limits. However, both options provide clear inefficiencies for landfill compaction by respectively reducing the degree of compaction possible from the reduced release height and lowering the rate of compaction due to the down-time in changing the impact device.

Patent application WO 2000/28154 discloses a trailer-mounted compactor intended for relatively small areas of soil compaction, in which the compactor is pivotally attached to the rear of a trailer to lie flat against the trailer for movement, and raised upright for compaction operations. There is however no disclosure how the device may be utilised for deep compaction of landfills or how the inherent difficulties in landfill compaction discussed herein may be addressed. The relatively small impact weight and associated mounting and lifting structure are unsuitable for up-scaling for deep compaction on an undulating landfill surface of variable consistency.

Patent application WO 2004/003301 by the same inventor discloses an extension to the compactor disclosed in WO 2000/28154 which utilises on-board monitoring means to measure feedback from the compaction impact to determine properties of the soil. However, it does not provide a means of monitoring the seismic effect of the impacts to maximise the compaction effects within regulatory vibration constraints.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention there is provided a compactor including:
a transporter;
an impact tool,
a lifting mechanism capable of lifting the impact tool to a raised position;
a substantially elongate support mast coupled to the lifting mechanism and capable of supporting the raised impact tool, and
a mast stabilising system
   characterised in that the stabilising system is capable of adjusting the orientation of the support mast to allow the impact tool to descend substantially vertically from said raised position without the transmission of any lateral force by the tool to the support mast.

The impact tool is essentially a large mass used as a hammer/penetrator to crush refuse and the voids therein. The impact tool may take a variety of configurations though most preferably, is formed as a block (optionally elongated) or element with an impact face and lower tool tip shaped to penetrate uniformly into the refuse surface without being deflected or deviated from the vertical impact axis. Preferably, the tool tip is slightly tapered, to facilitate extraction of the tool after impact.

In one embodiment, the impact tool is provided with a laterally enlarged portion above the impact face. The enlarged portion or collar serves to prevent over-penetration into the refuse (which may make the impact tool unduly difficult to extract), and provides a visual indicator for the operator to maintain a uniform penetration depth.

The lifting mechanism may take any convenient form such as a pulley system, chain drive, ram drive (pneumatic, hydraulic or the like), a combination of same or any other sufficiently powerful means of reliably raising the impact tool to the raised position. Thus for example, the lifting mechanism may include a wire rope hoist configuration driven though multiple reduction sheaves via a hydraulic ram. The impact tool may be pulled from above (e.g. raised by pulley system attached to the upper portion of the support mast) or pushed from underneath, e.g., using one or more ram drive(s) acting on a lug projecting from the side of the impact tool.

In one embodiment, the impact tool is configured to travel inside the support mast, preferably attached to moveable guides adapted to slide along tracks, rails or similar. It will be readily appreciated the guides may be attached to the impact tool and the corresponding tracks located on the inside of the mast or vice-versa.

In an alternative embodiment, the impact tool is configured to be slideably coupled to an exterior longitudinal portion of the mast, capable of being lifted to the raised position and descending substantially parallel to, but exterior from the longitudinal axis of the mast.

In a yet further embodiment, the impact tool may be raised by the lifting mechanism and/or allowed to descend completely unrestrained by the support mast. It will be appreciated that in such a configuration, any movement of the compactor during raising or lowering of the impact tool may cause the impact tool to oscillate about its coupling to the lifting mechanism, causing potential instability and/or damage to the compactor. Moreover, such a system would be limited in its capacity to impact adjacent portions of the surface in an accurate systematic pattern unless the impact tool was stationary at the commencement of its descent and this in turn also depends on whether the compactor is stationary as the impact tool is raised.

To achieve compaction to a greater depth than conventional prior art compactors, the present invention employs a very substantial impact tool to achieve a high level of impact energy. The practicality of simply using a compactor with a significantly increased static weight is limited by the aforesaid difficulties in preventing such a massive compactor sinking into the refuse surface and the necessary motive power unit required for such a vehicle. Using a kinetic impact tool enables the total weight of the transporter to remain manageable whiles allowing high pressure levels to be applied. To optimise the benefits of such a configuration, the present invention utilises a substantially sized impact tool. While the specific size may naturally be varied without departing from the scope of the invention, an exemplary compactor configuration includes a 40,000 kg mass being lifted to a raised position 12 metres above the refuse surface.

In one embodiment, the impact tool descends from the raised position under gravitational force. However, in an alternative embodiment, the impact tool may be assisted during descent. The assistance may be provided by a number of means including biasing means (spring, buffers and the like), chain, belt or ram drives and/or any other suitable mechanism. It will be appreciated that by accelerating the impact tool to a super-gravitational descent rate, a lower impact tool mass may be used to produce the same impact energy as a larger mass falling under gravity alone. Equally, raising the impact tool to a greater height also provides a means for increasing the impact energy and/or decreasing the impact tool size.

Using the example configuration of a 40,000 kg mass with a 1 m² area impact face falling under gravity for 12 m and coming to rest over 0.3 m, the impact pressure generated is 1,500,000 kg/m² This equates to approximately 50 times the pressure of the largest wheeled compactors; or equivalent to the pressure exerted at the base of a landfill 1.5 kilometres deep. The high forces involved in raising and lowering such a large mass could create potential hazards for the stability of the compactor.

Thus, the present invention addresses the above complications of using such a large impact tool over the non-homogenous surface of a refuse site by use of the stabilising system which ensures the impact tool is free to descend without transmitting any lateral force to the support mast. It will be seen that due to the large kinetic energy levels involved, any misalignment of the support mast preventing the impact tool descending vertically would transmit a significant lateral force to the compactor which may cause damage and/or (in the case of large mast misalignments) possibly overturn the compactor.

Preferably, the stabilising system is also capable of maintaining the support mast in an orientation avoiding any lateral force on the impact tool during lifting to its raised position. The kinetic energy of the impact tool while being raised will be lower than that during descent, due to the lower velocities involved. Nevertheless, stabilisation of the mast (and thus the impact weight) during lifting of the impact tool enables the compactor to simultaneously move to its next location. This reduces the overall time cycle between successive impacts, thereby increasing efficiency.

The stabilisation system may be automatic, semi-automatic, or even manually operable. A fully automated system may be implemented in several configurations utilising some form of position sensors and actuators. The position sensors are used to detect the position of the support mast, absolutely and/or relative to the transporter. The sensor data is used by a stability control means to determine the orientation of the support mast and any deviation from a vertical position. The stability control means outputs control signals to actuators (e.g. electrical, hydraulic or pneumatic drives) capable of adjusting the mast orientation to correct any deviation detected. Such an automatic stabilisation system may perform corrections dynamically to ensure the mast is continuously aligned in a vertical orientation.

In addition to an impact crater and sub-surface compaction, the violent collision of a heavy mass with the refuse surface causes shock waves to radiate through the refuse. The goal of landfill compaction is to maximise the physical compression of the refuse material within any applicable environmental, practical and legislative constraints.

Given that most landfill sites have regulations governing the allowable ground vibration limits, it is desirable to achieve the maximum practicable compaction effect per impact of the mass without exceeding these seismic limits. The magnitude and propagation of the shock waves (or ‘seismic effect’) is dependant on numerous variables including the composition and structure of the refuse, the moisture content and the nature of the impact tool deceleration.

Considering a tool falling from a given height, the kinetic energy of the tool at the moment of impact will remain constant provided the mass remains constant. The impact force will be determined by the rate of declaration of the tool

A prolonged deceleration dissipates the kinetic energy of the impact tool over a longer period (i.e. a lower rate of change of momentum) thus applying a lower force impact to the surrounding material. Conversely, a rapid deceleration causes a high rate of momentum change producing a correspondingly higher impact force.

Thus, after an initial impact tool strike has been performed in a given area and the surface compacted to a degree, a subsequent tool impact in the same area would generate higher impact forces due to the more rapid deceleration generated by the hardened surface.

However, the rate of deceleration of a given mass also depends on the shape and surface area of the impact face and the consequential effect on the pressure applied by the tool impact face.

The present invention overcomes the problem of increased impact forces for areas of increased surface hardness by providing the compactor with a means of varying the pressure applied by the tool during impact and thereby maintaining a substantially constant seismic impact effect.

Thus, according to a further aspect, the present invention is configured such that the impact tool includes a variable area impact face.

The area of the impact face may be varied in a wide variety of means. According to one aspect, the impact tool includes a variable area impact face, said face including two or more portions, at least one portion being movable to either overlap with at least one other portion or be removed from the impact face. In one embodiment, at least one said impact face portion is detachable from the impact face, and preferably capable of being reattached to a separate portion of the impact tool to maintain a constant total impact tool mass.

In a further embodiment, at least one moveable portion is pivotally or slideably attached to allow variable overlap with at least one other impact face portion. In some embodiments, the impact face may include a fixed portion to provide greater strength; whilst in an alternative embodiment, the entire face may be composed of moveable portions which co-operatively overlap to a variable degree.

Preferably, the total weight of the impact tool remains substantially constant for any change in impact face area. Maintaining a constant weight for the impact tool means the resultant kinetic energy generated during each descent remains constant. Thus, as the surface becomes hardened and denser through previous impact tool strikes, the area of the impact face may be reduced to increase the impact pressure, causing greater penetration. As the tool deceleration occurs over a greater distance, the impact shock is reduced from that which would otherwise have been generated by the hardened surface. Thus an increased penetration may still be achieved in the pre-compacted surface without exceeding the impact force generated during the previous compacting of the area. As the impact area of each strike is reduced, the compactor is required to adjust the increments between strikes.

To optimise the compaction potential of the present invention, the compactor ideally needs to accurately know the compactor location (to plot the position of successive tool strikes) and the amount of seismic effect generated per strike. Thus, according to a further embodiment, the present invention further includes a position location system and/or a seismic sensing system

In one embodiment, at least one seismic sensor is located remotely from the compactor and/or on the compactor, wherein seismic measurement data is transmitted from the sensors to an impact control means. The impact control means incorporates logical processing capability, associated circuitry and interconnects, and may also serve to provide other logical control functions associated with the compactor, such as stabilisation control. Thus, in one embodiment, the stability control means and impact control means are provided by a common control system. Moreover, it will be understood to one skilled in the art that the logical control means is not to be interpreted in a restrictive sense as being a single unit or device, but alternatively subsist in a two or more computing devices operatively interfaced or networked together, located onboard, or remote from the compactor. Remotely positioned sensors and/or control means may communicate with the compactor via any convenient known means including wireless communications.

The impact control means may be used to monitor the seismic effect of each impact and alert the operator to vibration levels approaching a predetermined threshold and/or (in a fully automated embodiment) activate corrective action between subsequent tool strikes. The corrective action may range from a reduction in the area of the tool impact face, or even reducing the release height of the tool. Adjustments to the tool impact face area may be made be an operator or, in some embodiments, automatically according to control signals from the control means.

Convenient position location systems include the global positioning system (GPS) which can provide very high level of three-dimensional positional accuracy. Thus, a GPS-based system may be used to determine the elevation of the compactor on the landfill surface in addition to its horizontal position. Naturally, alternative location sensor systems may be employed, including radio triangulation, radar, microwave and the like. The use of accurate position measurement of the compactor, and the position of tool impacts, enables a systematic compaction of the landfill to be performed. The position of successive strikes may be performed in an incremental sequence of overlapping, contiguous, or closely spaced strikes.

It will also be appreciated that control of the compactor movements and impact tool strikes may be performed remotely from the compactor. Such remote control allows the mitigation of operator exposure to operational hazards such as noise, vibration, and surface gas emission.

The physical configuration of the transporter, support mast and impact tool may also take several forms.

Spreading the weight of the compactor over a wide area is one means of reducing the risk of the compactor getting stuck. The transporter may include caterpillar tracks, wheels, skids or a combination of same. Tracks offer the greatest resistance to becoming stuck; may be configured to be self-propelled, and are reliable. The entire mast, tool and lifting mechanism assembly may be carried on a transporter with a single pair of tracks. However, placing the mast, impact tool and lifting mechanism on a bridge portion spanning separate tracks, is a preferable configuration due to:
an improved weight distribution;
separation of the tool impact point away from the transporter tracks with an improved ability to observe the effects of the impact;
increased compactor stability through the ability to place tracks on firm ground away from impact.

The compactor transporter may include a symmetrical configuration with two substantially identical, preferably tracked, drive units separated by the bridge portion. Alternatively, the transporter may include a powered base with a pair of tracks connected by the bridge portion to a simplified single drive outrigger unit. In both such configurations, the support mast, impact tool and lifting mechanism is preferably positioned on the bridge spanning the tracked units, ideally such that ground pressures under the tracks are equalised. Although any appropriate type of drive may be employed such as toothed wheels, half track s and the like, for the sake of clarity, the present invention is henceforth described with reference to tracked drives, though this should not be seen as limiting. As used herein, the term drive unit also included powered and un-powered, freewheeling drives

In preferred embodiments, a bridge portion is pivotally or articulately coupled to the separate tracked units, enabling the separate tracked units to operate at different elevations. This is a significant advantage in a systematic compaction process by enabling one of the tracked units to run in the compacted lower ground after an initial series of tool strikes has formed a compacted trench or plateau. The difference in height between the tracked units requires the stabilisation system to make corresponding corrections to maintain a vertical orientation of the support mast and impact tool. However, the inclination of the bridge portion between tracked units at different heights may be reduced by providing the lower unit with an elevating mechanism to raise the bridge portion attachment point. It will be appreciated that an elevating/lowering mechanism may be incorporated into both drive units (enabling the compactor to traverse a bench layout in either direction) or restricted to one of the units, which has sufficient range to maintain the bridge substantially on the level whether the drive unit is in a trench or on a plateau.

It will also be appreciated the above referenced stabilisation system may also be extended to other facets of an embodiment with a bridge portion and two or more drive units. Stabilisation applied between the support mast and the compactor transporter may be subdivided into stabilising actions performed by actuators operating between the;
support mast and bridge portion,
the bridge portion and drive unit (s) and/or
drive unit(s) and the adjacent refuse terrain surface.

In a yet further embodiment, the stabilisation system includes actuators operable between a drive unit and said elevation mechanisms. In each instance, the stabilisation system applies inputs to the stabilisation actuators to ensure the alignment of the support mast remains substantially vertical to ensure the impact tool is able to descend vertically without applying any lateral force to the support mast.

Stabilisation between the transporter and the adjacent terrain is implemented by actuators acting on support legs deployed from the compactor. Such stabilising support legs are commonly utilised in many forms of lifting and earth working machinery, mobile cranes, diggers, cherry pickers and the like. However, in such applications, the support legs are lowered into contact with the ground and braced before any destabilising forces are applied to the vehicle. However, in the present invention, the large mass of the impact tool, particularly in its raised position, may cause stability problems for the compactor as the compactor traverses the undulating and variable density refuse surface. In instances of such sudden instability, due to the movement of the compactor, there may be insufficient time for the support legs to deploy before the compactor pitches over or damage occurs.

According to a further aspect of the present invention, said stabilisation system further includes support legs deployable from the compactor to an adjacent terrain surface, wherein the support legs are configured to trail over the terrain surface in an un-locked mode, unless an activation signal is received from said stability control means indicating the orientation of support mast deviates from the vertical by more than a predetermined angle, whereupon at least one support leg is locked to prevent further angular deviation and preferably, apply corrective movement to re-align the support mast vertically.

Thus, by allowing the support legs to remain in a continual standby position of instant readiness, the stabilisation system may act rapidly to prevent a roll-over or other instability. Allowing the support legs (typically powered by hydraulic rams) to trail over the landfill surface in the condition known as ‘float’ (i.e. the actuator ram that raises and lowers the support leg is configured with all the valve ports open, preventing any force being exerted on the support leg), there is no delay in bringing the support leg in contact with the refuse surface. To avoid excessive drag caused by the trailing support legs, the underside of the contact portion of each support leg is contoured to slide over the surface. As soon as the impact tool is being dropped, or (optionally) lifted and the activation signal is received, the ram valve locks, locking the stabilizer to the ground to provide more stability. If the roll rate of the whole compactor exceeds a certain value during movement over the landfill site, or if the whole machine inclines past a predetermined angle, then the support legs may also be configured to lock.

The above-described compactor provides numerous efficiency improvements in the compaction of landfills and may be employed on existing landfill sites with or without implementing all the various features described above. The present invention also provides for advantageous methods of constructing, filling, compacting and managing a landfill site using the above described compactor, and in some embodiments, prior art compactors.

More specifically, the present invention provides a method of landfill compaction of a landfill tract composed of a plurality of strips utilising a compactor substantially as hereinbefore described, said method including the steps:
1. providing a compactor substantially as herein before described;
2. positioning the compactor for compaction of a first strip of a landfill tract to be compacted;
3. raising and lowering the impact tool to perform one or more impacts at a given location
4. moving the compactor a predetermined distance to an adjacent location along the strip;
5. raising and lowering the impact tool to perform one or more impacts at said adjacent location;
6. repeating steps 4 and 5 until the strip is compacted;
7. repositioning the compactor to compact a subsequent strip of the tract;
8. repeating steps 3-7 until all the constituent strips of the tract have been compacted.

Preferably, adjacent locations are contiguous, closely-spaced or at least partially overlapping. Preferably, adjacent strips are substantially parallel. In a preferred embodiment the transporter drive is capable of indexed movement, whereby each impact tool raise and descent cycle is indexed to a fixed distance movement of the drives.

Thus, a uniform, continuous and systematic compaction may be applied to any portion or tract of the landfill surface.

According to a further embodiment, said compaction method utilises seismic data feedback from one or more seismic sensors, said method including the steps of:
determining the seismic magnitude of a preceding impact tool strike, and comparing to a predetermined threshold level; characterised in that:
   for impact magnitudes less than said threshold level, for subsequent strikes:
      the impact tool is raised to a greater height before release; and/or
      the impact face area of impact tool is increased and/or
      the impact tool mass is increased,
   and for impact magnitudes greater than said threshold level;
      the impact tool is raised to a lower height before release; and/or
      the impact face area of impact tool is decreased and/or
      the impact tool mass is decreased

The present invention also provides an enhanced method of constructing and operating a landfill for collection of landfill generated gas (particularly methane), said method including the steps of
filling said landfill with refuse in a plurality of layers;
compacting said layers;
applying greater compaction to different portions of said layers to create regions with reduced gas permeability in regions of greater compaction and areas of greater gas permeability in regions of reduced compaction;
placing gas collection means in one or more areas of greater gas permeability, and
collecting said gas.

Applying differing degrees of compaction to differing regions, areas of greatest compaction will become more impermeable to gas and to moisture which is key to decomposition of the organic material in the refuse. Thus, by selective application of the increased levels of compaction, the relatively uncompacted areas become focal points for the production and collection of methane and other gases. Thus, gas collection means such as perforated conduit and the like inserted through the refuse layers may collect a far higher proportion of the generated gas than would otherwise be possible in a homogenously compacted landfill.

Over time, the collection of gas from a designated area and the consequential reduction in refuse density due to the decomposed material will cause the overlying refuse to crush the voids generated. The gas collection means may then be re-located to other regions which have become (or been made) comparatively more permeable and less dense. Thus, the gas collection sites may be systematically relocated over the lifetime of the landfill to ensure maximum gas collection in conjunction with selective compaction to produce density and/or permeability gradients between different regions.

According to a further embodiment the impact tool includes at least one penetrator e.g. a spike, pin, pipe or the like for penetrative impact with the landfill. In use, driving the penetrator into the landfill and subsequently withdrawing provides an elongated aperture into the landfill. The aperture may be used to tap gas pockets in the landfill or promote decomposition by permitting air to permeate through the aperture and to collect gas generated by the decomposing landfill. In the prior art, gas collection has typically been performed on uncompacted, or ‘conventionally’ compacted (by existing compaction techniques) sites which are thus prone to significant settling as the organic landfill matter decomposes and settles. Consequently, the gas collection holes formed in the relatively ‘soft’ material require ‘sleeving’ to ensure the aperture avoids collapse. Furthermore, typical prior art apparatus required to form apertures for gas reticulation collection in landfills generally comprise a drilling rig or the like and thereby require a considerably longer period of time to drill to depth than a single impact device such as the present invention as aforementioned.

In contrast, the present invention is able to significantly enhance the effectiveness of such gas collection by utilisation of two, above-described, features, i.e. the penetrator and the systematic method of compaction.

Where the landfill has been compacted to the enhanced levels capable using the present invention, the apertures formed by the penetrator may be utilised without sleeving due to the enhanced structural integrity of the compacted material surrounding the hole. Thus, according to a preferred embodiment, the present invention provides a method of operating a landfill for collection of landfill generated gas substantially as hereinbefore described, said method further including the steps of:
using an impact tool as hereinbefore described includes at least one penetrator to form a plurality of apertures in the landfill;
placing said gas collection means at one or more said landfill apertures without sleeving said aperture, and
collecting said gas.

Preferably, said landfill aperture is capped by a sealable extraction conduit placed in the aperture and extending to the surface. Thus, only a relatively small and inexpensive device, e.g. capping pipe, is required for each hole, in contrast to prior art systems which require considerable lengths of ‘sleeving’ which must be withdrawn or left in the landfill upon further compaction or addition of landfill material. Consequently, the present invention enables a large number of such landfill apertures to be formed quickly, and without the costs associated with individually sleeving each aperture.

The penetrator may be formed integrally with the impact tool, and move in unison therewith. Alternatively, the penetrator may be formed as a discrete element of a minority mass detached from, or slideably attached to, the remainder of the impact tool having a majority mass, the penetrator being configured to receive impacts in use from the majority mass to form said apertures. The specific ratio of mass between the minority mass of the penetrator and the majority mass of the main impact tool body may be selected according to the particular constraints of the compactor and its intended application. It is however self-evident to one skilled in the art it is desirable that the penetrator be lighter (preferably substantially lighter) than the remainder of the impact mass. Not only does this more efficiently transfer momentum of the impact into penetration of the landfill surface, it also facilitates the ease of removal of the embedded penetrator from the landfill.

The optimal depth of an aperture to effectively tap landfill-generated gas may exceed the stroke length of the impact tool. Consequently, the penetrator may be composed of a plurality of sections, in a comparable configuration to a drill string, fed sequentially into the aperture. The maximum number of penetrator sections that may be effectively employed is determined by the extracting power of the compactor and the frictional properties of the landfill material bounding the aperture.

Thus, according to a yet further embodiment, said penetrator includes a plurality of connectable sections capable of being sequentially attached and driven into a common aperture.

According to a further aspect, the present invention provides a method of constructing and/or operating a landfill for collection of landfill generated gas using the compactor including said penetrator substantially as hereinbefore described, said method including the steps of
filling said landfill with refuse in a plurality of layers;
compacting said layers;
applying greater compaction to different portions of said layers to create regions with reduced gas permeability in regions of greater compaction and areas of greater gas permeability in regions of reduced compaction;
forming one or more apertures in said landfill using said penetrator
placing gas collection means with one or more apertures, and
collecting said gas.

As previously referred to, moisture is also a key factor in the decomposition of organic matter in the landfill. Whilst moisture levels between 20-70% are suitable for decomposition, moisture values outside these limits pose difficulties.

A significantly dry landfill may only be subjected to limited compression due to the small quantity of decomposition that can occur. The lack of moisture may be due to climatic conditions, the landfill capping layer being too tightly sealed with no access for moisture ingress, or the leachate either not recycled or not present.

Excessively high moisture levels may also cause problems due to the potential for impact tool strikes to cause liquefaction of the landfill surface, while the excess water may prevent displacement of the voids in the landfill and thus hinder compaction. Thus, excessively moist landfills may require dewatering of all or part of the landfill immediately prior to the compaction process.

Thus, according to a further aspect, the present invention includes a method of managing landfill moisture content, said method including the steps of
determining if landfill moisture levels fall outside a predetermined range, wherein
   for moisture levels below said predetermined range, one or more localised decomposition-accelerants are inserted into the landfill;
   for moisture levels above said predetermined range, the landfill surface permeability is decreased to reduce moisture ingress, and/or moisture is actively extracted, preferably by pumping.

The decomposition accelerants make take any convenient form including drilling, or otherwise aperturing (e.g. using the above-described penetrator) the refuse surface to increase the permeability to moisture or configuring the contours of the landfill surface to increase natural water flow over the surface. In areas of low rainfall, decomposition acceleration may be achieved by pumping water into the landfill through the drill sites.

It can be thus seen that the present invention provides a particularly advantageous compactor and means of landfill compaction, capable of increasing landfill efficiency and reducing the time before the completed landfill site is usable for further purposes.

### BRIEF DESCRIPTION OF DRAWINGS

Further aspects of the present invention will become apparent from the following description which is given by way of example only and with reference to the accompanying drawings in which:

FIG. 1 shows a front elevation of a first preferred embodiment of the present invention in the form of a landfill compactor;

FIG. 2 shows a side elevation of the embodiment shown in FIG. 1;

FIG. 3 shows a plan view of the compactor shown in FIG. 1;

FIG. 4 shows a side elevation of the second preferred embodiment of the present invention;

FIG. 5 shows a front elevation of the embodiment shown in FIG. 4;

FIGS. 6a-d show a series of front elevation views of the compactor shown in FIG. 4 in use on a landfill surface;

FIG. 7a shows a front elevation of the first embodiment of an impact tool with a variable area impact face for use with the compactor of the present invention;

FIGS. 7b-d show side elevations of the impact tool shown in FIG. 7a with variations in the impact face area;

FIGS. 8a-f show further embodiments of impact tools with a variable area impact face;

FIG. 9 shows a schematic illustration of the successive compaction of the landfill by successive impact tool strikes;

FIG. 10 shows a series of enlarged side elevation views of an impact tool compacting a bench portion of a landfill;

FIGS. 11a-b show a side section elevation of a landfill compactor with a penetrator attached;

FIG. 12 shows a side section elevation of a landfill compactor with a multi-piece penetrator attached, and

FIG. 13 shows a side section view of a hole capping conduit according to one embodiment.

### BEST MODES FOR CARRYING OUT THE INVENTION

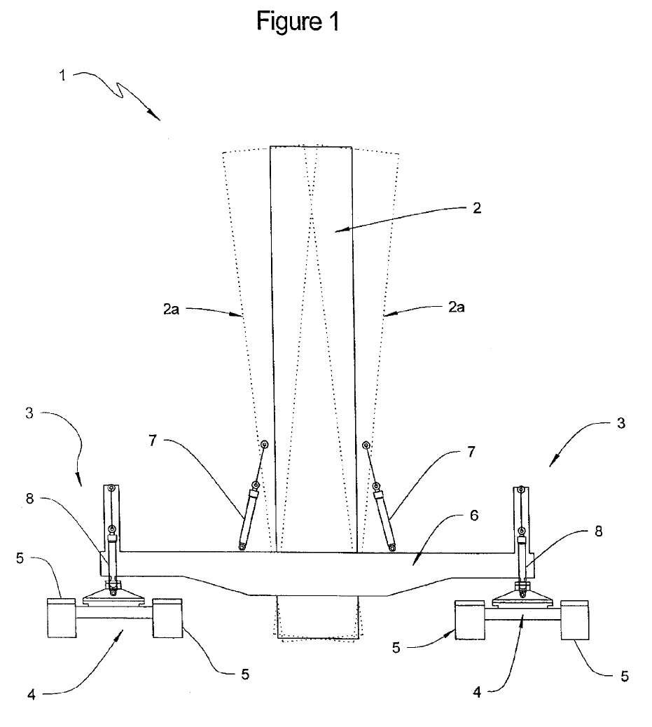

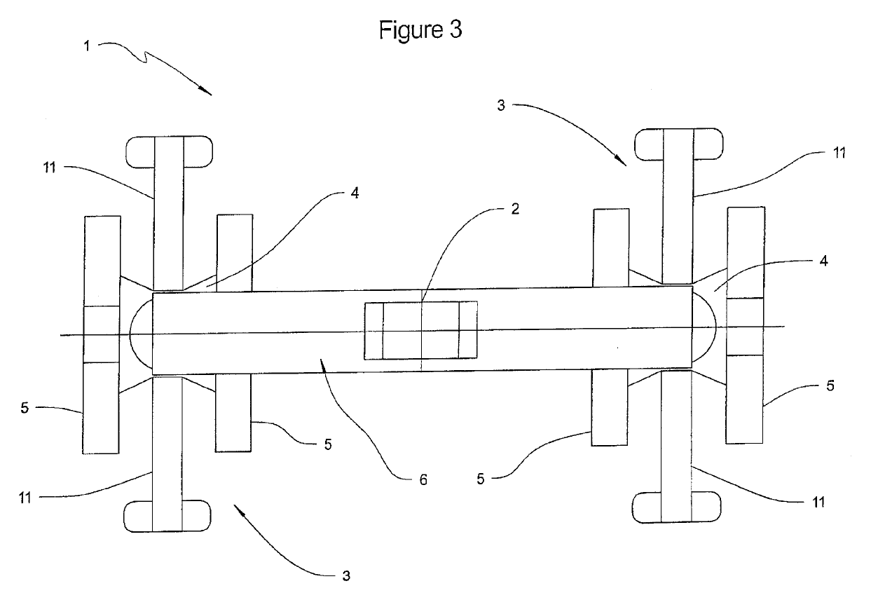

The present invention utilises a compactor specifically adapted for use on landfill refuse sites and the like. FIG. 1-3 show a first embodiment of a compactor (1) consisting generally of a support mast (2) supported on a transporter (3). The embodiment of FIGS. 1-3 utilises a transporter (3) in the form of a pair of twin tracked drive units (4) each provided with a pair of caterpillar tracks (5).

The transporter further comprises a bridge portion (6) which joins both drive units (4) in a transverse arrangement such that both drive units (4) are able to move substantially parallel to each other. The bridge portion (6) is also pivotally coupled to the support mast (2) at the centre point of the bridge portion (6), equidistantly between the drive units (4). The support mast (2) is a substantially elongated frame capable of a variable orientation with respect to the bridge portion (6) (shown by the dotted lines in FIGS. 1-3 and represented by the reference numeral 2a) via a pivotal coupling located towards the lower portion of the mast (2). In alternative embodiments (not shown) the mast may be pivotally attached towards its centre or upper portion.

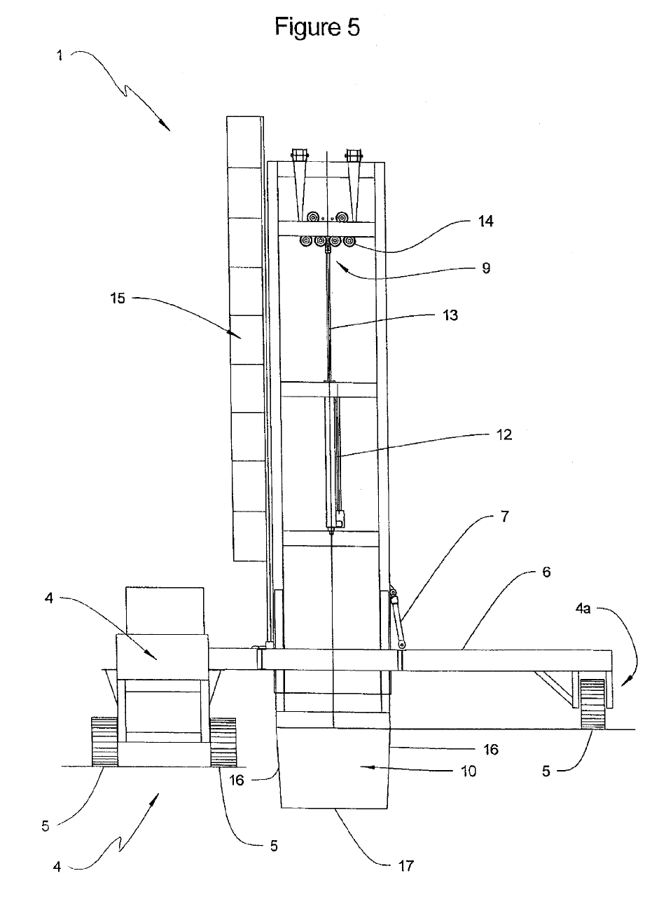

Control over the support mast (2) orientation is effected by a mast stabilising system including a plurality of mast actuators (7) and bridge portion/drive unit stabilising actuators (8) (shown in FIG. 1). The mast stabilising system is configured to maintain the support mast (2) in a vertical alignment irrespective of the movement of the compactor (1) and the relative inclination and position of the drive units (4) and bridge portion (6). Keeping the support mast (2) accurately vertically aligned enables a lifting mechanism (9) (shown in FIG. 5) to raise and lower an impact tool (10) without de-stabilising or damaging the compactor (1). The lifting mechanism (9) and impact tool (10) (not explicitly shown in FIGS. 1-3) are coupled to the support mast (2) and in conjunction with the stabilising effect of the mast stabilising system, allow the impact tool (10) to be raised and lowered by the lifting mechanism (9) without applying any lateral force or moment to the support mast (2).

As the impact tool (10) is typically made as a substantially massive block (e.g. approximately 40,000 Kg), any misalignment of the support mast (2) from the correct vertical orientation during raising or lowering of the impact tool (10) may cause the impact tool (10) to apply pressure laterally against the support mast (2) potentially causing serious instability and/or damage to the compactor (1).

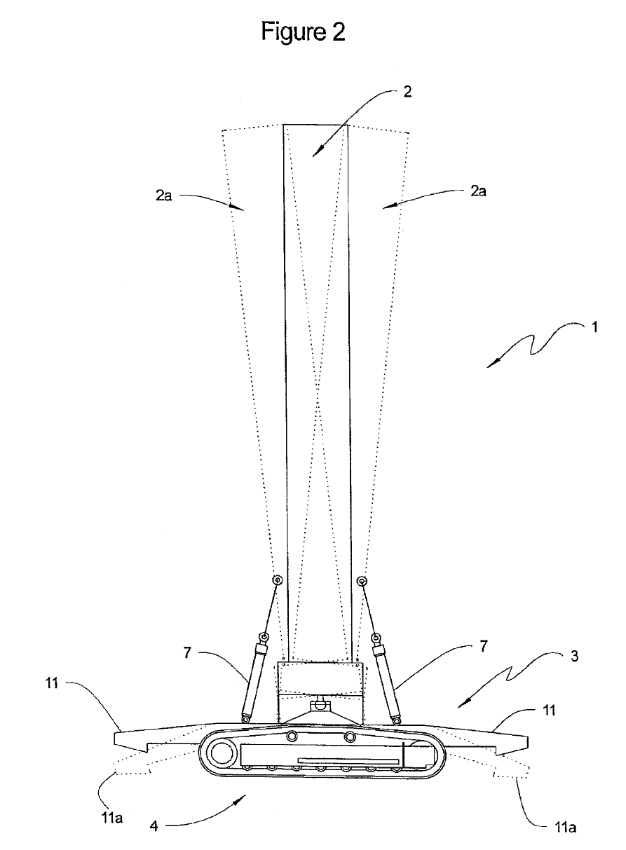

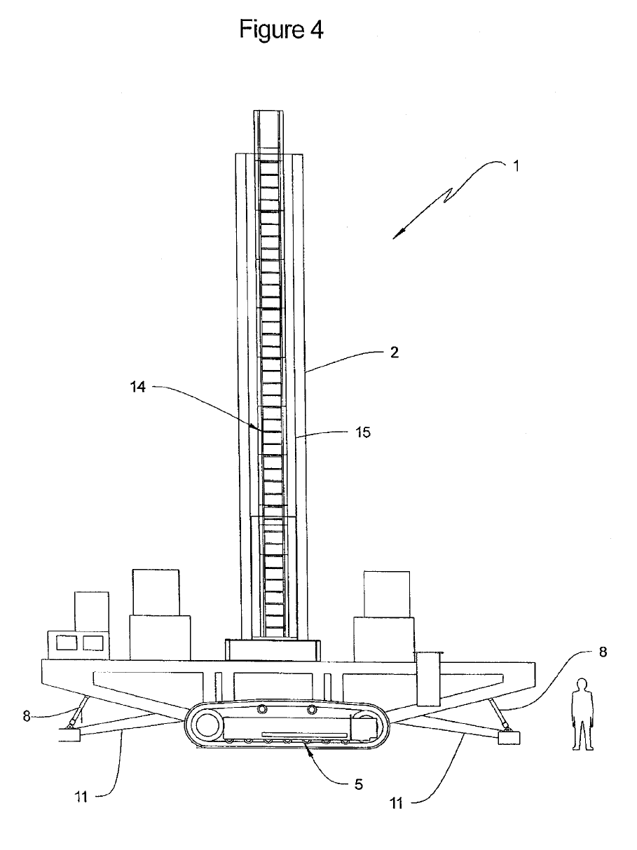

With respect to FIGS. 2-4 further stabilising means are provided in the form of deployable support legs (11) which may be raised or lowered via further actuators (8) (shown in FIG. 4) under the control of the mast stability system and provide a means of further stabilising the raising or lowering of the impact tool (10). To ensure instantaneous stabilising effect, the support legs (11) may be deployed in a position known as ‘float’ whereby the lower surface of the support legs (11) effectively trail across the surface of the terrain in a passive, unlocked configuration where no force is placed on the legs by the controlling actuators (8). In the event of the compactor pitching or rolling beyond a permissible degree and/or during lifting/descending of the impact tool (10) the support legs (11) may be locked into position providing additional support.

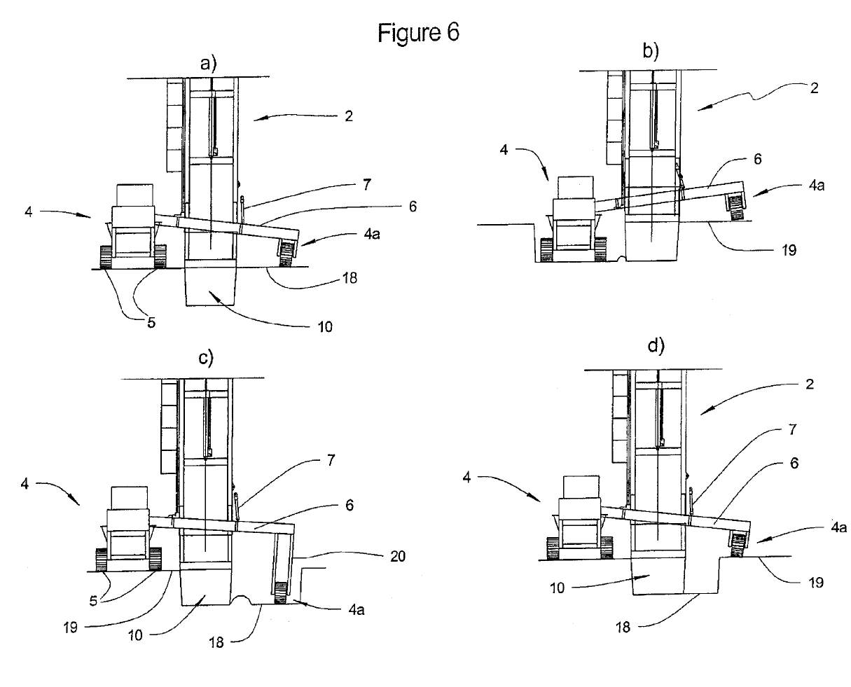

FIGS. 5 and 6 show a further embodiment in which the symmetrical configuration of two identical drive units (4) used in the first embodiment are replaced by an asymmetrical arrangement with a main drive unit (4) with twin tracks (5) at one end of the bridge portion (6) and a single tracked support drive unit (4a) at the other end of the bridge portion (6). In this embodiment, the main drive unit (4) contains an engine powering both tracks (5) whilst the single tracked drive unit (4) may (optionally) be un-powered or contain an individual power source and/or receive distributed power from the other main drive unit (4) via appropriate coupling.

FIG. 5 shows more clearly one form of lifting mechanism (9) composed of a ram drive (12) which acts via a wire or nylon cable (13) through reduction sheaves (14) to lift the impact tool (10). When the impact tool (10) reaches its predetermined maximum height, it may be released to descent under the force of gravity, passing through an aperture in the bridge portion (6) to strike the refuse surface below. In alternative embodiments (not shown) the impact tool (10) may be powered in its decent to achieve an increased downward acceleration.

In the embodiments shown in the drawings, the impact tool (10) is configured to slide within the support mast (2), guided by rails (not shown) on an interior portion of the support mast (2). It will be appreciated however that the impact tool (10) need not be internally constrained within the support mast (2) and may be coupled to slide parallel, though externally to, the support mast (2). In further embodiments (not shown), the impact tool (10) may be completely unrestrained by the support mast (2) and coupled to the compactor (1) solely via the lifting mechanism (9). In such a configuration where the impact tool (10) is essentially allowed to swing free under its own weight. It will be appreciated that the support mast (2) requires accurate stabilisation to ensure the impact tool (10) does not swing into the support mast or any other portion of the compactor (1). FIGS. 4 and 5 also show a ladder and safety cage (15) provided alongside the support mast (2) for access and maintenance.

It can also be seen in FIG. 5 that the impact tool (10) is formed with slightly tapering sides (16) and a substantially planar impact face (17). In use, after the impact tool (10) has formed an impact crater in the refuse surface after being raised by the lifting mechanism (9) and released, the compactor (1) moves forward a pre-determined amount in a direction substantially perpendicular to the bridge portion (6) and parallel to the drive units (4). Successive impacts form a compacted trench (18) as shown in FIG. 6. The series of illustrations in FIGS. 6a-f show the compactor (1) embodiment of FIGS. 4-5 in use at differing stages of landfill compaction. The articulated connection of the bridge portion (6) to the main drive unit (4) enables the support drive unit (4a) to traverse the landfill at a different elevation to the main drive unit (4). This is particularly useful after a trench (18) has been formed from successive impacts and either of the drive units (4, 4a) is required to traverse along the newly formed trench (18) with the other of the drive units (4, 4a) remaining on the higher ground. FIG. 6a shows the compactor forming a new trench with both drive units (4, 4a) on the same level. FIG. 6b shows the main drive unit (4) operating in the previously formed trench (18) whilst the support drive unit (4a) tracks along the uncompacted refuse surface (19). FIG. 6c shows the converse configuration in which the main drive unit (4) remains on the uncompacted surface (19) whilst the support drive unit (4a) travels along the surface of the compacted trench (18).

In order to minimize the necessary travel for the mast stabilising actuator (7) to maintain the support mast (2) in vertical alignment, the support drive unit (4a) is provided with an elevation mechanism (20) capable of varying the height of the support drive unit (4a) attachment to the bridge portion (6). The elevation mechanism (20) may be formed from any convenient configuration such as telescopic struts, scissor linkages, hydraulic rams and the like.

FIG. 6d illustrates an unfavourable position for forming a second compacted trench (18) in which both the main drive unit (4) and the support drive unit (4a) are positioned on the same uncompacted surface (19) resulting in the support unit (4a) travelling adjacent to the uncompacted edge of the previous trench (18) which is likely to be unstable for such weight bearing applications. The compacting methods shown in FIGS. 6b and 6c overcome these disadvantages by ensuring both drive units (4, 4a) travel on stable ground.

Landfill sites are typically subject to impact vibration restrictions governed by regulatory or local authorities' requirements. To maximize the efficiency of landfill compaction within such constraints, the compactor (1) is able to utilise input from seismic sensors (not shown) which may be located on the compactor (1) and/or at remote locations about the landfill site and which transmit seismic data to an impact control means (not shown).

The impact control means may be a discrete unit or form part of other logical processing systems and associated communication means located on the compactor (1) or remotely and may be programmed to control the impact magnitude of the strikes. The impact force caused by its strike may be varied by adjusting the height of the impact tool (10) before release and/or by varying the area of the impact face (17) of the impact tool (10), as described more fully below.

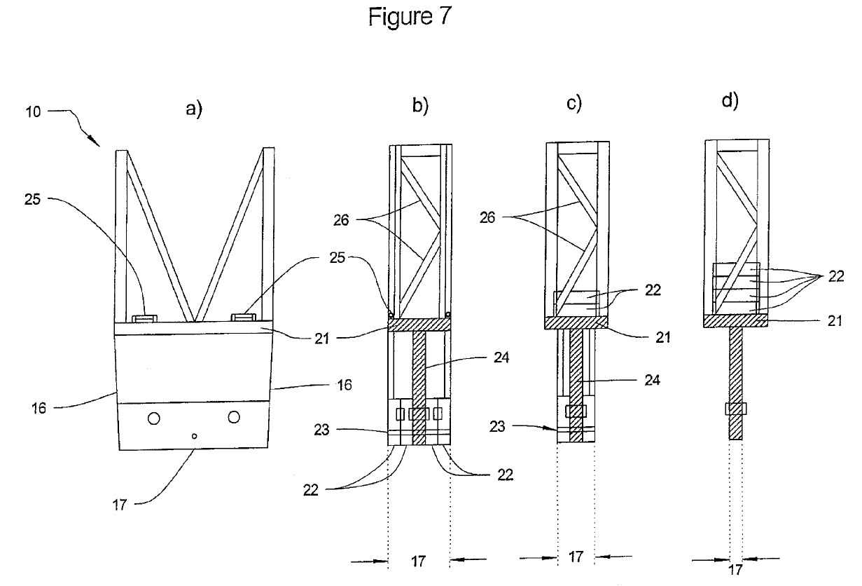

FIG. 7 shows one embodiment of the impact tool (10) with a variable area impact face (17). The tool (10) is composed of a base portion (21) extending transversely across the width of the tool (10) with a plurality of moveable portions (22) attached to the lower surface of the base portion (21) in a series of laminations held together with a tie-bolt (23) to a central fixed portion (24). The combination of moveable portions (22) and fixed portion (24) collectively form, at their lower most point, the impact face (17) of the tool (10). The area of the impact face (17) is adjusted by simply removing one or more of the moveable portions (22). The total mass of the impact tool (10) may be maintained at a constant value by placing the removed moveable portions (22) and securing them above the base (21) as shown in successive stages in FIGS. 7c and 7d in which two and four moveable portions (22) are respectively relocated on top of the base (21).

It will be seen therefore that in FIGS. 7b-d, the area of the impact face (17) is successively reduced in each illustration. FIG. 7a-d also shows the lifting points (25) to which the wire (13) (not shown in FIG. 7) is attached to lift the impact tool (10), together with structural bracing framework (26).

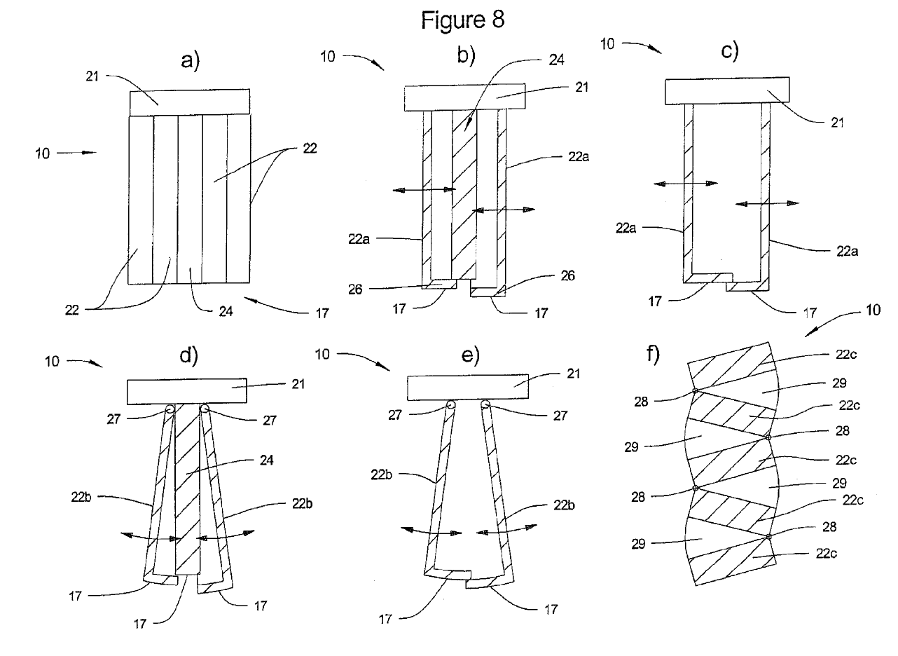

FIGS. 8a-f show further embodiments of impact tools (10) with their variable area impact face (17). FIG. 8a shows a simplified schematic embodiment of the embodiment shown in FIG. 7a-d. FIG. 8b shows an embodiment of the impact tool (10) also provided with a base (21) and fixed blade portion (24) and further provided with the addition of two additional moveable portions (22a) configured to move laterally to the plane of the impact face (17).

Each moveable portion (22a) is formed as a complimentary elongated substantially cuboid element with facing side open. Foot portions (26) on each movable portion (22a) at least partially overlap the impact face (17) of the fixed blade (24) and (according to the degree of separation of the two moveable portions (22a)) are capable of interlocking with each other. This has the resulting effect of varying the exposed lower surface area of the two moveable portions (26, 22a) and the fixed portion (24) forming the impact face (17).

FIG. 8c shows a variant of that shown in FIG. 8b in which the fixed portion (24) is omitted. The impact face (17) is thus provided solely by two moveable and overlapping portions (22a).

FIG. 8d shows a further variant to that shown in FIG. 8b in which the base (24) and fixed portion of the base (21) and fixed portion (24) are retained while the moveable portions (22c) are attached via pivots (27) at the intersection of the base (21) and fixed portion (17). Thus, the distal ends of the moveable portions (22b) move in an arc constrained to at least partially overlap the impact face (17) portion of the fixed panel (24) and each other. Thus, by varying the angular separation of the two moveable portions (22b), the area of the impact face (17) may be varied.

FIG. 8e shows a variant of the embodiment in FIG. 8d with the fixed portion (24) omitted. It will be appreciated that in such an embodiment, the two moveable portions (22b) are restricted from moving apart to a degree which would leave a separation between the two lower impact face impact portions (17).

FIG. 8f shows a yet further embodiment of the impact tool (10) shown in plan view in which the moveable portions (22c) are attached to an adjacent moveable portion (22c) on an opposing longitudinal edge at a hinged point (28). Thus, the entire assembly may be concatenated or expanded by laterally separating the moveable panels between the non hinged edges.

FIGS. 7a-d also show the lifting points (25) to which the wire (13) (not shown in FIG. 7) is attached to lift the impact tool (10), together with structural bracing framework (26). The portions between the moveable panels (22c) shown in FIG. 8f are spanned by plates (29) attached to the lower end of the moveable sections (22c) and configured to at least partially overlap as the impact tool assembly (10) is concatenated to reduce the impact face (17) area.

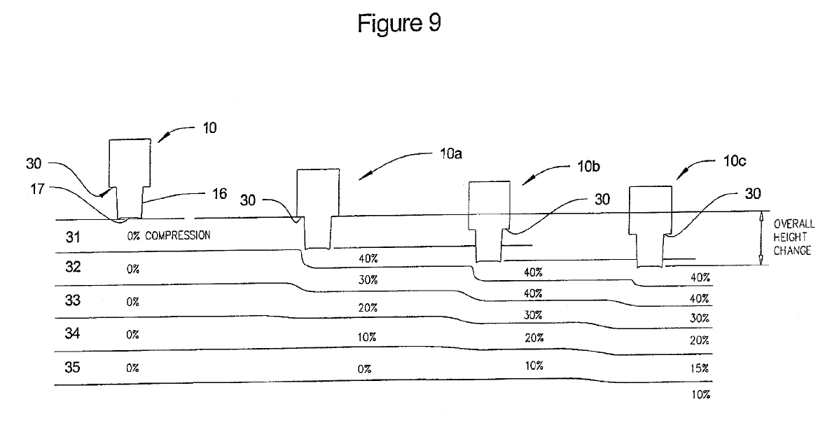

FIG. 9 shows a yet further variant of the impact tool (10) incorporating an enlarged shoulder (30) at the upper portion of the tool sides (16). The shoulder (30) serves to prevent over-penetration of the tool into the refuse surface and also provides a visual indicator to the operator to ensure uniform penetration depth.

FIG. 9 also shows the impact tool (10) being successively impacted on a landfill site illustrating the compaction effects on the top layer (approximately ten metres) segmented into two metre increments (31, 32, 33, 34, 35). Successive impacts by the impact tool (10) (denoted in FIG. 9 as 10a, 10b, 10c respectively) show that for the initial impact tool (10a) strike, the first layer (30) is heavily compressed and the impact tool (10) penetrates up to the shoulder portion (30).

The maximum achievable compression in any given layer is approximately 40% and any excess compaction is transmitted through to underlying layers. Thus, the second and third layers (32, 33) are compacted to a lesser degree, i.e. 30% and 20% respectively, while the lower two layers (34, 35) are only compressed by 10% and 0% respectively. The second and third strikes of the impact tool (10b, 10c) penetrate less into the surface as the upper layers become more compacted resulting in the compaction effect being transmitted deeper into the refuse pile. It will be appreciated that by varying the area of the impact face (17), the impact tool (10) would be able to penetrate further into the refuse further increasing compaction whilst avoiding an increase in the impact force.

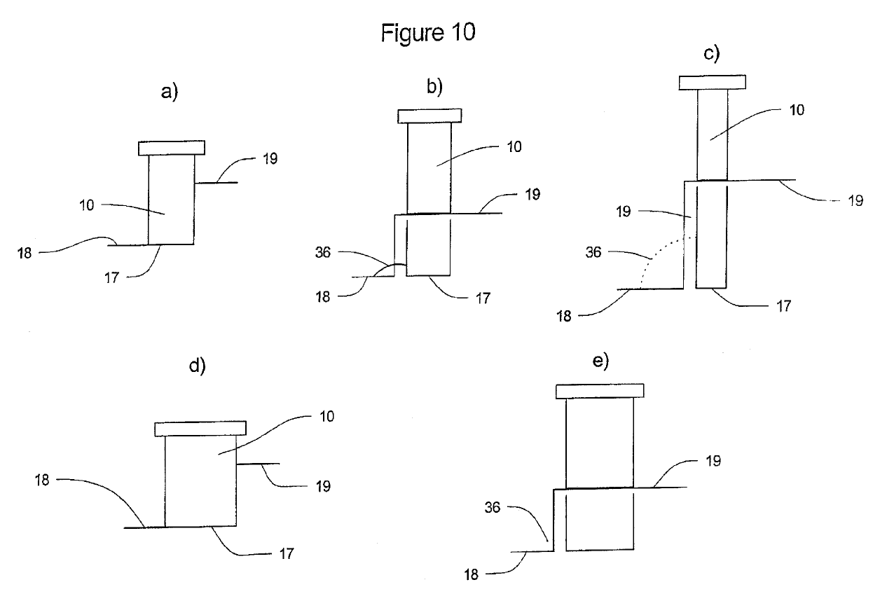

FIG. 10 contrasts different impact face (17) shapes. It is more efficient to perform small incremental movements with the compactor to compress a broad trench rather than more rapid movements to compact a narrow trench. FIGS. 10a-c show the use of a rectangular shaped impact face (17) with a successively higher aspect ratio, i.e. making the rectangular footprint of the impact face (17) longer and thinner. However, if the impact face is made overly rectangular (e.g. FIG. 10c), the configuration can suffer potential draw-backs when used to compact friable material (such as uncompacted refuse (19)) which splits off from the surrounding material during impact rather than being carried into the impact crater, thus leaving an increased amount of uncompacted spoil (36). The use of a square shaped impact face (17) on the impact tool (10) as shown in FIGS. 10d-e produces a correspondingly smaller degree of spoil (36). However, after the surface has been subjected to an initial compacting coverage however, the refuse material behaves more like a plastic and is less susceptible to disintegrating when hit. Thus, a smaller degree of uncompacted spoil (36) is created surrounding each impact strike.

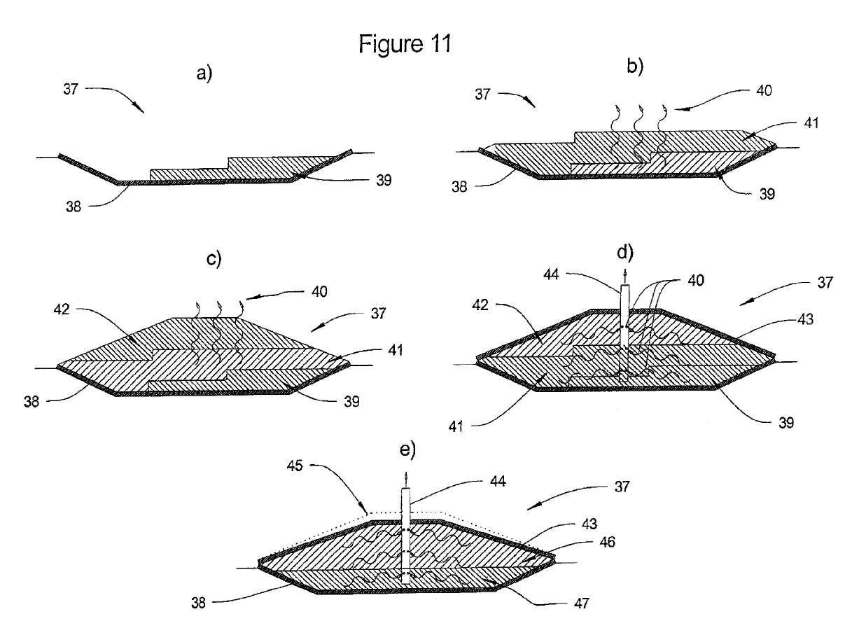

FIG. 11 shows a prior art method of constructing and filling a landfill site (37). A liner (38) is placed on the excavated surface bounding the volume to be used for the landfill (37) after which the first layer (39) of refuse is laid down and compacted with a roller compactor to a density of approximately 0.8 to 1.0 tonnes per cubic metre.

FIG. 11b shows stage two in which some of the refuse from stage one (39) rots and loses density due to the release of methane gas (40) which escapes through a second layer of refuse (41) laid over the first layer (39). The second layer (41) is again compacted using conventional roller compactors.

The density of the stage one refuse (39) decreases to approximately 0.6 to 0.8 tonnes per cubic metre due to the released gas.

FIG. 11c shows stage three in which a further layer of refuse (42) is laid down and is compacted as per the previous stages one and two. Typically, the landfill (37) is now full though the permeability of the refuse layers (39, 41, 42) still allows methane gas (40) to still be released. The stage two refuse (41) also rots giving off further methane gas (40) with a decrease in the resulting density to approximately 0.6-0.8 tonnes per cubic metre.

FIG. 11d shows the landfill (37) after a capping layer (43) is applied over the landfill surface. The capping layer (43) is of a low permeability material, constraining the methane gas being produced by the refuse layers (39, 41, 42) to be restricted from escaping through the entire landfill (37) surface. Collection pipes (44) are inserted through the capping layer (43) and through the refuse layers (39, 41, 42) to concentrate collection of the methane gas (40).

FIG. 11e shows stage five in which the landfill (37) has been closed for a period of time and settlement due to the release of the methane gas (40) has occurred. The capping layer (43) has thus become displaced in a lower position from the original volume boundary position (45) at the original time of closing the landfill (37).

Considering an example volume of landfill being 100,000 cubic metres, the average density of the landfill at the point of closure in stage four (FIG. 11d) would be approximately 50% at 0.7 tonnes per cubic metre and 50% at 1.0 tonne per cubic metre (represented schematically in FIG. 11e as refuse layers 46 and 47 respectively). Thus for a total of 85,000 tonnes the gas generated up to the point of closure would be approximately 15,000 tonnes. If the input rate of the landfill (37) was 10,000 tonnes per year, the life of the landfill would be approximately ten years, whilst the gas generation after the closure would be approximately 15% or 13,000 more tonnes.

The present invention provides an improved means landfill construction and operation over the above prior art method. Firstly, the landfill (37) efficiency defined as the percentage of airspace in the landfill may be improved simply by use of the compactor (1) as hereinbefore described due to its superior compaction abilities. The following landfill construction and operation method preferably utilises such a compactor (1), though it should be understood prior art compactors may be used, albeit with reduced effectiveness. The following example is thus based on using a conventional toothed roller compactor to illustrate the advantages of the method over the prior art.

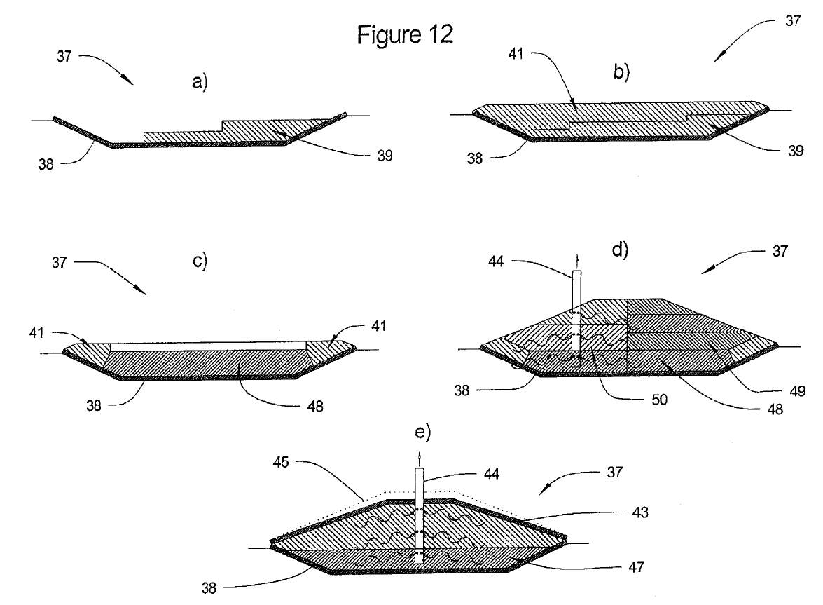

FIG. 12a shows stage one of filling an equivalent landfill site (37) to that represented in FIG. 11, initiated by placement of a liner (38) over the lower terrain surface. A first refuse layer (39) is laid down in benches approximately 3 m high and compacted and the resultant density is approximately 0.8-1.0 tonnes per cubic metre.

Stage two, illustrated in FIG. 12b involves the laying down and compacting of a second refuse layer (41) creating a resultant depth of approximately 10 m with a density of 0.9-1.0 tonnes per cubic metre.

FIG. 12c shows stage three in which the centre portion (48) of the landfill (37) is further compacted to a density of 1.3-1.4 tonnes per cubic metre. The edge portions (41) of the landfill (37) are not compacted beyond the effects of stage two to avoid any damage to the liner (38).

FIG. 12d shows stage four in which further refuse portions (49) laid down over the centre portion (48) are subjected to a repeated cycle of refuse filling and compaction to produce approximately the same density as of the centre portion (48). As the lower layers rot, the high density of the upper layers (49) crushes the lower layers maintaining the density. The remaining area (50) of landfill above the centre portions (37) is filled with further refuse layers though compacted to a lesser extent. Thus a density gradient is formed between the upper landfill areas (49, 50) with a commensurate effect on permeability. Thus, the methane gas generated from the rotting refuse is naturally channelled from areas of low permeability (i.e. the highly compacted area (49)) to areas of high permeability (the less compacted area (50). Placing gas collection pipes (44) in the high permeability areas thus enables the volume of collected methane (40) to be optimised.

When the permeability of the collection area (50) drops below an adjacent area (49), the area may then be highly compacted (to 1.3-1.4 tonnes per cubic metre) and the gas collection points (44) moved to the adjacent area.

FIG. 12e) shows stage five in which the landfill is sealed with a capping layer (43) as per the prior art method. Comparing a numerical example with the prior art method described above for a landfill volume of 100,000 cubic metres, the average density of the total landfill (37) at the instance of sealing would be approximately 40% at 1.3 tonnes per cubic metre and 60% at 1.1 tonnes per cubic metre. This gives a total mass of 118,000 tonnes and a generated gas volume of approximately 20,000 tonnes at the time of sealing.

Assuming an annual input rate of 10,000 tonnes, the lifespan of the landfill is thus 13.8 years. Furthermore, gas generation after closure will be approximately a further 15% or 18,000 tonnes.

The rotting of the organic portions of the refuse is thus a useful side effect in terms of liberating additional landfill volume and also for producing methane gas. However, degradation of the organic material is highly dependant on the moisture content and is proportional to moisture content between values of approximately 20% moisture content to 90% saturation.

As discussed above, it is desirable to decompose as much of the organic material as rapidly as possible to recoup landfill volume and reduce the period after sealing of the landfill before the land can be used for alternative purposes.

Furthermore, un-decomposed organic matter creates a long-term liability as eventually decomposition will occur, up to hundreds of years later. This is particularly likely if the landfill has low moisture content (either due to environmental/climatic conditions and/or the landfill cap is well sealed) and breaks down over an extended period. Buildings may have been erected over the old landfill or in close proximity which may be in jeopardy from possible subsidence and toxic gas emission. Although the landfill operator is responsible for stabilization and remediation, this period typically extends only for 30 years at which time some of the above problems may not yet have manifested. However, if the landfill can be decomposed as rapidly as possible the liability is mitigated and the land can be used safely for other purposes.

The rate of methane gas generation determines the viability of capturing the gas for power generation.

Currently, low uneconomic gas yields per cubic metre of landfill are flared or just left to vent to atmosphere. Clearly, neither is environmentally beneficial.

Landfills are typically filled to a volume limit and then sealed, irrespective of the organic content, density, moisture content or final settlement after the time of closure. Commonly this size limit is reached when the majority of the landfill volume comprises low density un-rotted organic material. Thus, any decomposition that can be achieved in the landfill allows more material in before closure.

Consequently, the moisture content of the landfill is an import factor in landfill compaction. Depending on several environmental factors, the moisture content may vary resulting in the following conditions:
1. Very dry landfills.
   Only limited compression may be achieved due to the small quantity of decomposition that can occur. The landfill may be dry due to the local climate or the landfill capping layer is tightly sealed with no access for moisture ingress, or the leachate is either not recycled or not present.
2. “Normal” landfills.
   Landfills with typical moisture levels present ideal conditions for decomposition to occur in most situations. However, if the main ingress of water is via percolation of rain through the surface there may be a need to drill the hard surface left by the compactor to reintroduce water to continue the decomposition process. Surface runoff may also cause difficulties, requiring a calculated solution to define the optimum top contour of the landfill to avoid surface runoff and ensure the water is retained in the landfill.
3. Wet landfills.
   Excessively high moisture levels may cause problems for two main reasons. Firstly, the impact tool strikes may cause liquefaction of the landfill surface with attendant issues for stability and safety of the compaction operation. Secondly the excess water may prevent displacement of the voids in the landfill and thus hinder compaction. Further, the incompressible nature of water may cause a ‘hydraulic-type transfer of the impact forces causing unwanted side effects to the landfill structure.
   Consequently, it may be necessary to dewater all or part of the landfill immediately prior to the compaction process.

Thus, in further embodiments (not shown), the present invention includes a method of managing the moisture content of the landfill.

If, after the moisture levels have been determined, insufficient moisture is present for decomposition, one or more localised decomposition-accelerants may be inserted into the landfill. The accelerants make take any convenient form including simply drilling the refuse surface to increase the permeability to moisture. In areas of low rainfall, the decomposition accelerates may include pumping water into the landfill through the drill sites.

In landfills with excess water, moisture management techniques may include
decreasing the permeability of the landfill surface to reduce moisture ingress in areas of high rainfall, and/or
actively extracting moisture from the landfill including pumping.

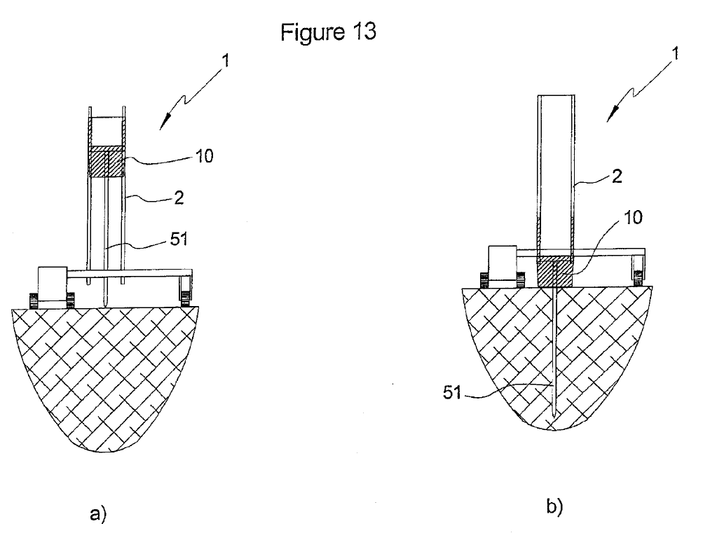

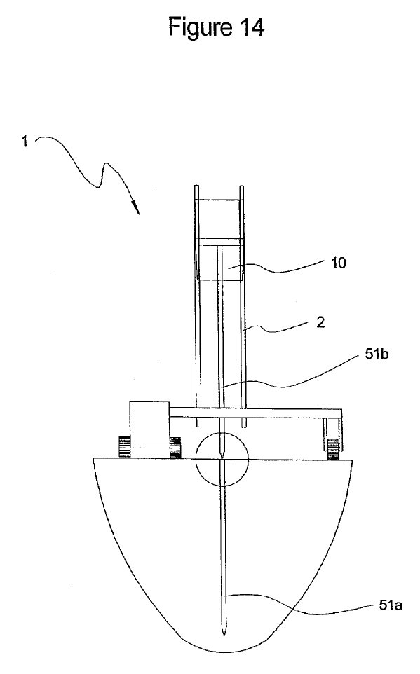

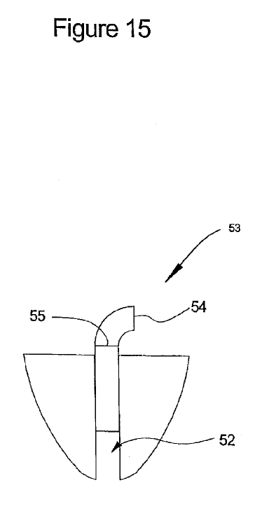

FIG. 13 shows a schematic diagram of a landfill compactor (1) according to a further preferred embodiment wherein the impact tool (10) includes a penetrator in the form of spike (51). The spike (51) enables the compactor (1) to form numerous apertures in the landfill without need for recourse to drilling or the like.

According to one embodiment, in use, the impact tool (10) is raised and spike (51) placed against the surface of the landfill (shown in FIG. 13a) and subsequently driven into the landfill (shown in FIG. 13b) by lowering the impact tool (10). The spike (51) may be withdrawn to provide a hole in the landfill to tap gas pockets or promote decomposition by permitting air to permeate through the hole. The very high pressure levels capable of being exerted by the spike (51) during impacting operations enables landfill apertures to be formed even in heavily compacted landfill regions.

In the prior art, gas collection has typically been performed on uncompacted, or ‘conventionally’ compacted (by existing compaction techniques) sites which are thus prone to significant settling as the organic landfill matter decomposes and settles. The gas collection holes formed in such ‘soft’ material required sleeving to ensure the apertures avoid collapse. The use of the compactor (1) with the spike (51) in compacted landfills avoids the need for such burdensome infrastructure, in addition to the manifold decrease in the total time required to create and utilise each landfill aperture.

Variations in landfill configurations and compositions may require landfill apertures of different lengths and widths to be formed. However, the optimal landfill aperture depth may exceed the stroke length of the impact tool (10). Consequently, (as shown in FIG. 14), the effective spike-length may be increased to provide a deeper hole by providing multiple sections (51a,b), a first (51a) of which may be driven into the landfill and the second (51b) subsequently driven into the first (51a). Although shown schematically, it will be understood that adjacent sections (51a,b) are mutually connectable, thus ensuring each section (51a,b) is lifted upward during extraction.

The simplicity of the gas reticulation infrastructure associated with the present embodiment provides a significant economic and operational improvement over the prior art. In the absences of any time consuming drilling and sleeving of landfill apertures (52), gas may simply be collected by a capping pipe (53) (shown in FIG. 15) inserted into the upper portion of the hole (52) formed by the spike (51). The ease of creating each aperture (52) and ability to omit sleeving of the aperture (52) may make it economically viable to form the capping pipes (53) as disposable items, which are simply compacted into the landfill after use rather than re-used with new apertures (52).

In use, a conduit (not shown) may be attached to the outlet (54) of each capping pipe (53) to convey the gas to a suitable collection reservoir (not shown). It will be appreciated that the capping pipe may include a valve (55), vents or the like to alter the rate of gas egression or to release pressure. In the embodiment shown in FIGS. 13-14, the penetrator (51) is formed integrally with the impact tool (10) and moves in unison with same. However, in alternative embodiments (not shown), the penetrator (51) may be formed as separate element detached from the impact tool (10). In use, the penetrator (51) is placed in contact with the landfill surface and driven in to the ground by the falling impact tool (10). The penetrator is proportionally significantly lighter than the mass of the impact tool (10). In a yet further embodiment (not shown) the spike (51) is slideably attached to the impact tool (10) allowing the spike (51) to be extracted from the landfill surface in conjunction with raising the impact tool (10).

Aspects of the present invention have been described by way of example only and it should be appreciated that modifications and additions may be made thereto without departing from the scope thereof.

1. A compactor including:
a transporter;
an impact tool,
a lifting mechanism capable of lifting the impact tool to a raised position;
a substantially elongate support mast coupled to the lifting mechanism and capable of supporting the raised impact tool, and
a mast stabilisation system
characterised in that the stabilising system is capable of adjusting the orientation of the support mast to allow the impact tool to descend substantially vertically from said raised position without the transmission of any lateral force by the tool to the support mast.

2. A compactor as claimed in claim 1, wherein said impact tool is formed as an elongated block with an impact face and lower tool tip shaped to penetrate uniformly into the refuse surface without being deflected or deviated from the vertical impact axis.

3. A compactor as claimed in claim 1, wherein said tool tip is slightly tapered, to facilitate extraction of the tool after impact.

4. A compactor as claimed in claim 1, wherein the impact tool is provided with a laterally enlarged portion above the impact face.

5. A compactor as claimed in claim 1, wherein the impact tool is configured to travel inside the support mast

6. A compactor as claimed in claim 1, wherein the impact tool is attached to moveable guides adapted to slide along tracks or rails.

7. A compactor as claimed in claim 1, wherein the impact tool is configured to be slideably coupled to an exterior longitudinal portion of the mast, capable of being lifted to the raised position and descending substantially parallel to, but exterior from the longitudinal axis of the mast.

8. A compactor as claimed in claim 1, wherein the impact tool is configured to be capable of being raised by the lifting mechanism and/or allowed to descend completely unrestrained by the support mast.

9. A compactor as claimed in claim 1, wherein the impact tool is configured to descend from the raised position under gravitational force.

10. A compactor as claimed in claim 1, wherein the impact tool is assisted to a super-gravitational descent rate.

11. A compactor as claimed in claim 1, wherein said stabilising system is configured to maintain the support mast in use in an orientation avoiding any lateral force on the impact tool during lifting to its raised position.

12. A compactor as claimed in claim 1, wherein said stabilisation system is fully automated utilising position sensors and actuators, wherein said position sensors detect the position of the support mast, absolutely and/or relative to the transporter.

13. A compactor as claimed in claim 12, wherein sensor data outputted by said sensors is used by a stability control means to determine the orientation of the support mast and any deviation from a vertical position.

14. A compactor as claimed in claim 13, wherein the stability control means outputs control signals to actuators capable of adjusting the mast orientation to correct any deviation detected.

15. A compactor as claimed in claim 1, wherein the impact tool includes a variable area impact face.

16. A compactor as claimed in claim 15, wherein said face includes two or more portions, at least one portion being movable to either overlap with at least one other portion or be removed from the impact face.

17. A compactor as claimed in claim 16, wherein at least one said impact face portion is detachable from the impact face.

18. A compactor as claimed in claim 17, wherein said impact face portion is capable of being reattached to a separate portion of the impact tool to maintain a constant total impact tool mass.

19. A compactor as claimed in claim 16, wherein at least one said moveable portion is pivotally or slideably attached to allow variable overlap with at least one other impact face portion.

20. A compactor as claimed in claim 15, wherein the impact face includes a fixed portion.

21. A compactor as claimed in claim 15, wherein the entire impact face is composed of moveable portions which co-operatively overlap to a variable degree.

22. A compactor as claimed in claim 15, wherein the total weight of the impact tool remains substantially constant for any change in impact face area.

23. A compactor as claimed in claim 1, further including a position location system and/or a seismic sensing system.

24. A compactor as claimed in claim 23, wherein at least one seismic sensor is locatable remotely from the compactor and/or on the compactor, wherein seismic measurement data is transmissible from the sensors to an impact control means.

25. A compactor as claimed in claim 24, wherein the stability control means and impact control means are provided by a common control system.

26. A compactor as claimed in claim 1, configured for remote control of the compactor movements.

27. A compactor as claimed in claim 1, wherein said transporter is configured substantially symmetrically in plan view with two substantially identical drive units separated by a bridge portion.

28. A compactor as claimed in claim 1, wherein said transporter further includes a powered drive unit with a pair of tracks connected by a bridge portion to a single tracked outrigger drive unit.

29. A compactor as claimed in claim 1, wherein the support mast, impact tool and lifting mechanism are positioned on a bridge spanning two drive units.

30. A compactor as claimed in claim 29, wherein the bridge portion is pivotally or articulately coupled to the separate drive units, enabling the separate tracked units to operate at different elevations.

31. A compactor as claimed in claim 29, wherein said stabilisation system is capable of applying stabilisation between the support mast and the compactor transporter performed by actuators operable between at least one of;
the support mast and bridge portion,
the bridge portion and drive unit (s) and/or
the drive unit(s) and the adjacent refuse terrain surface.

32. A compactor as claimed in claim 31, wherein said stabilisation system includes actuators operable between a drive unit and said elevation mechanisms.

33. A compactor as claimed in claim 1, wherein said stabilisation system further includes support legs deployable from the compactor to an adjacent terrain surface, said support legs being configured to trail over the terrain surface in an un-locked mode, unless an activation signal is received from said stability control means indicating the orientation of support mast deviates from the vertical by more than a predetermined angle, whereupon at least one support leg is locked to prevent further angular deviation.

34. A compactor as claimed in claim 33, wherein upon receipt of an activation signal from said stability control means indicating the orientation of support mast deviates from the vertical by more than a predetermined angle, at least one support leg is configured to apply corrective movement to re-align the support mast vertically.

35. A compactor as claimed in claim 1, wherein the impact tool includes at least one substantially elongate penetrator.

36. A compactor as claimed in claim 35, wherein said penetrator may be formed integrally with the impact tool to move in conjunction therewith.

37. A compactor as claimed in claim 35, wherein said penetrator is formed as a discrete element detached from, or slideably attached to, the remainder of the impact tool.

38. A compactor as claimed in claim 35, wherein said penetrator includes a plurality of connectable sections capable of being sequentially attached and driven into a common aperture.

39. A method of landfill compaction of a landfill tract composed of a plurality of strips utilising a compactor as claimed in claim 1, said method including:
i. providing a compactor substantially as herein before described;
ii. positioning the compactor for compaction of a first strip of a landfill tract to be compacted;
iii. raising and lowering the impact tool to perform one or more impacts at a given location;
iv. moving the compactor a predetermined distance to an adjacent location along the strip;
v. raising and lowering the impact tool to perform one or more impacts at said adjacent location;
vi. repeating steps iv and v until the strip is compacted;
vii. repositioning the compactor to compact a subsequent strip of the tract;
viii. repeating steps iii-vii until all the constituent strips of the tract have been compacted.

40. A method as clamed in claim 39, wherein adjacent locations are contiguous or closely-spaced or at least partially overlapping.

41. A method as clamed in claim 39 or claim 40, wherein adjacent strips are substantially parallel.

42. A method as claimed in claim 39, wherein the transporter includes at least one drive capable of indexed movement, whereby each impact tool raise and descent cycle is indexed to a fixed distance movement of the drives.

43. A method as claimed in claim 39, wherein said compaction method utilises seismic data feedback from one or more seismic sensors, said method including the steps of:
determining the seismic magnitude of a preceding impact tool strike, and comparing to a predetermined threshold level, characterised in that:
for impact magnitudes less than said threshold level, for subsequent strikes:
the impact tool is raised to a greater height before release; and/or
the impact face area of the impact tool is increased and/or
the impact tool mass is increased,
and for impact magnitudes greater than said threshold level;
the impact tool is raised to a lower height before release; and/or
the impact face area of the impact tool is decreased and/or
the impact tool mass is decreased.

44. A method of constructing and/or operating a landfill for collection of landfill generated gas, said method including the steps of
filling said landfill with refuse in a plurality of layers;
compacting said layers;
applying greater compaction to different portions of said layers to create regions with reduced gas permeability in regions of greater compaction and areas of greater gas permeability in regions of reduced compaction;
placing gas collection means in one or more areas of greater gas permeability, and
collecting said gas.

45. The method as claimed in claim 44, wherein compacting said layers is performed by a compactor as claimed in claim 1.

46. The method as claimed in claim 44, further including:
using an impact tool as including at least one penetrator as claimed in claim 35 to form a plurality of apertures in the landfill;
placing said gas collection means at one or more said landfill apertures without sleeving said aperture, and
collecting said gas.

47. A method of managing landfill moisture content, said method including:
determining if landfill moisture levels fall outside a predetermined range, wherein
for moisture levels below said predetermined range, one or more localised decomposition-accelerants are inserted into the landfill;
for moisture levels above said predetermined range, the landfill surface permeability is decreased to reduce moisture ingress, and/or moisture is actively extracted.

48. A method as claimed in claim 47, wherein said predetermined moisture range is between 20-70%.

49-52. (canceled)
